(19) United States
(12) Patent Application Publication
(10) Pub. No.: US 2020/0117143 A1
(43) Pub. Date: Apr. 16, 2020

(54) BLOCKING DEVICE FOR A TIMEPIECE

(71) Applicant: PATEK PHILIPPE SA GENEVE, Genève (CH)

(72) Inventors: James HIDE, Plan-Les-Ouates (CH); Stéphane OES, La Chaux-De-Fonds (CH); Frédéric MAIER, Neuchâtel (CH)

(21) Appl. No.: 16/603,864

(22) PCT Filed: Apr. 17, 2018
(86) PCT No.: PCT/IB2018/052646

§ 371 Date: Oct. 9, 2019

(30) Foreign Application Priority Data
Apr. 18, 2017 (EP) 17166832.0

(51) Int. Cl. G04B 19/243; G04B 15/10; G04B 17/04; G04B 1/22; G04B 19/253

(52) U.S. Cl. CPC G04B 19/2434; G04B 15/10; G04B 19/253; G04B 1/22; G04B 17/04

(57) ABSTRACT

Disclosed is a timepiece blocking device including first and second mobile parts kinematically connected to one another, the first mobile part including a drive device, the second mobile part including a stopping device; a rotating drive member turning in a single direction and cooperating with the drive device to displace the first mobile part, and thus the second mobile part, alternately in opposite directions; and a rotating blocking member tensioned and cooperating with the stopping device to be blocked by the second mobile part and released at determined times by the displacements of the second mobile part. Cooperation between the rotating blocking member and stopping device immobilizes the mobile parts when the rotating drive member does not cooperate with the drive device. In normal operation, the rotating drive member contacts the first mobile part only when cooperating with the drive device, i.e. over less than 60% of one revolution of the rotating drive member.

The present invention relates to a blocking device for a timepiece, which is able to block a tensioned rotating member and to release it at determined times to control jump displacements of one or more wheels.

In watch and clock making, blocking devices may have various shapes. Document EP 1658531, for example, describes, in the context of a displaying mechanism, a blocking device comprising levers and a cam. This device is relatively complex and produces a great deal of friction.

There are also known blocking devices which are in the form of an anchor. This type of blocking device is particularly used in constant-force devices, also called “remontoires”, such as the Gafner constant-force device or the one described in document EP 2166419. The anchor comprises a fork which is in constant contact with a drive cam, as well as pallet stones which co-operate with a stopping wheel. This type of blocking device also produces a great deal of friction.

The present invention aims to remedy, at least partly, these drawbacks and proposes to this end a blocking device according to claim 1.

The present invention also proposes a timepiece mechanism comprising such a blocking device, and more particularly a timepiece mechanism according to claim 16 or claim 17.

Other features and advantages of the present invention will become clear upon reading the following detailed description given with reference to the attached drawings in which:

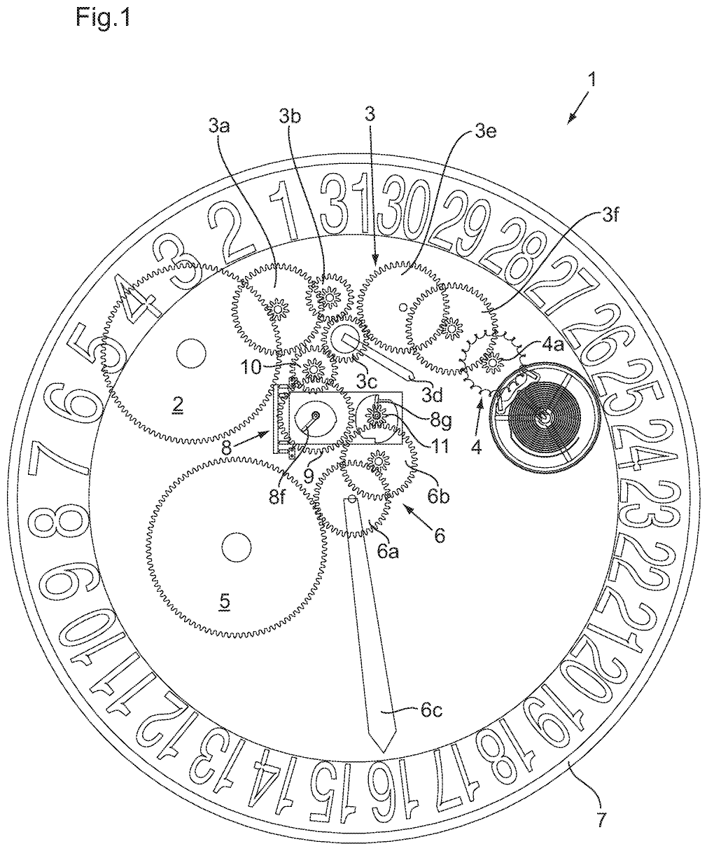

FIG. 1 is a top view of a first example of a timepiece mechanism comprising a blocking device in accordance with the invention;

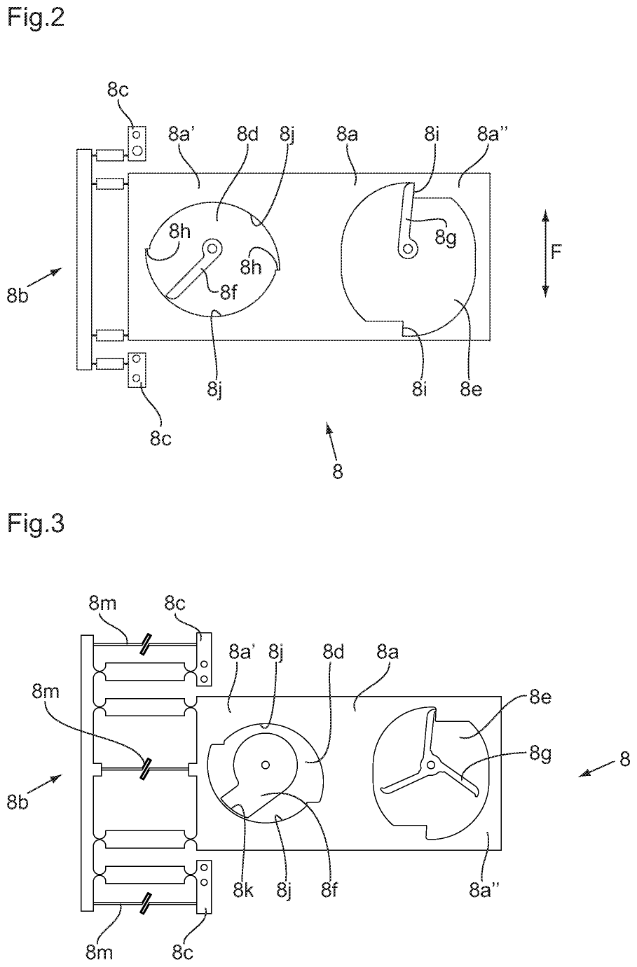

FIG. 2 shows the blocking device in accordance with the invention; for reasons of simplification, a flexible guiding device forming part of the blocking device is shown in this FIG. 2—as in FIGS. 3, 6 and 7 discussed below—in a rest state whilst in practice it is deformed;

FIG. 3 shows a blocking device in accordance with one variant of the invention;

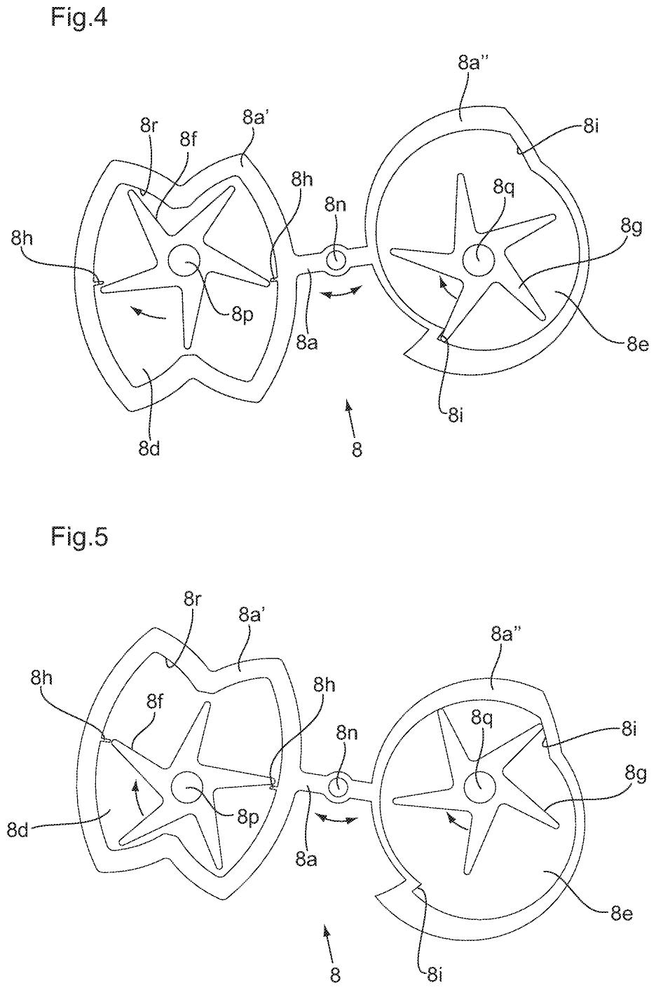

FIGS. 4 and 5 show a blocking device in accordance with another variant of the invention, in two different blocking positions;

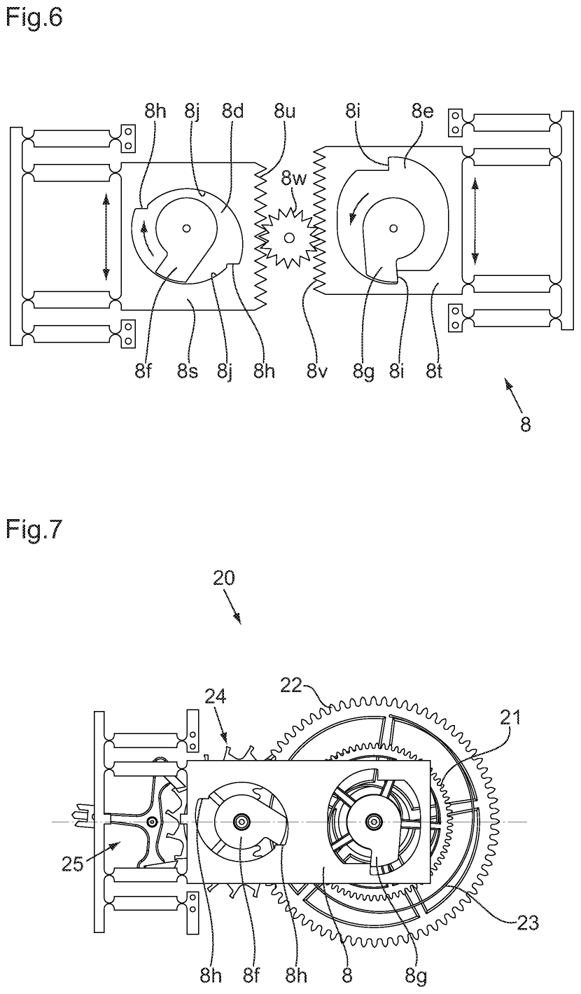

FIG. 6 shows a blocking device in accordance with yet another variant of the invention;

FIG. 7 shows a second example of a timepiece mechanism comprising the blocking device in accordance with the invention.

With reference to FIG. 1, a timepiece mechanism 1 for a timepiece such as a wristwatch or a pocket watch, comprises a first source of energy 2, a first gear train 3 and a regulating member 4. Typically, the first source of energy 2 is in the form of a barrel housing a mainspring and the regulating member 4 comprises a balance-hairspring and an escapement. In a conventional manner, the first source of energy 2 can be wound by the user using a manual winding mechanism and/or by an automatic winding mechanism (with oscillating mass). The first gear train 3 is a going gear train successively comprising, in the illustrated example, a great wheel-and-pinion assembly 3a, a third wheel-and-pinion assembly 3b, an hour wheel 3c carrying an hour-indicating hand 3d, an intermediate wheel 3e and a fourth wheel-and-pinion assembly 3f. The great wheel-and-pinion assembly 3a meshes with the barrel 2 whilst the fourth wheel-and-pinion assembly 3f meshes with an escapement pinion 4a of the regulating member 4.

The timepiece mechanism 1 further comprises a second source of energy 5 and a second gear train 6. Like the first source of energy 2, the second source of energy 5 is typically in the form of a barrel housing a mainspring. The first and second sources of energy 2, 5 are independent in the sense that neither of them provide energy to the other. In the illustrated example, the second gear train 6 comprises a date wheel 6a which meshes with the barrel 5 and a reducer wheel-and-pinion assembly 6b which meshes with the date wheel 6a. The date wheel 6a carries a date-indicating hand 6c directed towards a date scale 7 provided on a dial of the timepiece mechanism 1. However, as a variant, the indicating hand 6c could be replaced by one or more indicating discs co-operating with one or more apertures in the dial.

The timepiece mechanism 1 also comprises a blocking device 8 according to the invention for blocking and releasing the second gear train 6 under the control of the first gear train 3. This blocking device 8 comprises (cf. FIGS. 1 and 2) a mobile frame 8a which is guided in translation along the double arrow F by a flexible guiding device 8b. The flexible guiding device 8b is known per se. It is formed of a set of rigid parts and elastic parts, the set being fixed by two 8c of its rigid parts to the framework of the timepiece mechanism 1 and joined to the mobile frame 8a. Preferably, the flexible guiding device 8b forms a monolithic piece with the mobile frame 8a. The flexible guiding device 8b as shown is designed to eliminate the stray translational and rotational movements such that the mobile frame 8a moves purely in a translational manner. However, the present invention does not exclude the use of a simpler flexible guiding device, e.g. allowing a slight rotational displacement in addition to the translational displacement.

The mobile frame 8a has two openings 8d, 8e, the respective contours of which are closed. The first opening 8d receives a drive member 8f in the form of a finger which is coaxial with and fixed relative to a wheel 9 which meshes with the first gear train 3 via a reducer wheel-and-pinion assembly 10. The second opening 8e receives a blocking member 8g in the form of a finger which is coaxial with, and fixed relative to, a pinion 11 which meshes with the reducer wheel-and-pinion assembly 6b of the second gear train 6.

Two diametrically opposed offsets 8h in the wall of the first opening 8d form drive elements. Two diametrically opposed offsets 8i in the wall of the second opening 8e form stopping elements. Except at midnight, the blocking member 8g, which is tensioned by way of the torque exerted by the second source of energy 5, remains in abutment against one of the stopping elements 8i, which keeps the second source of energy 5, the second gear train 6 and the date-indicating hand 6c stationary. The drive member 8f is continuously driven by the first gear train 3 in the clockwise direction in FIGS. 1 and 2 at a rate of one revolution every 48 hours. Once every 24 hours, the drive member 8f contacts one of the drive elements 8h and then co-operates with it tangentially (in the manner of a gear) to displace the mobile frame 8a in translation during a time interval, e.g. one to two hours, overlapping midnight. At midnight, the displacement of the mobile frame 8a releases the blocking member 8g which loses the contact with the stopping element 8i on which it was in abutment. The second source of energy 5 is thus no longer held and the assembly 5, 6, 8g, 11 starts to turn until the blocking member 8g comes to abut against the other stopping element 8i and once again block the second source of energy 5 and the second gear train 6, a position in which the date-indicating hand 6c indicates the next date. The drive member 8f then leaves the drive element 8h with which it co-operated and continues its rotation without driving or touching the mobile frame 8a, the latter being immobilised by a slight draw exerted by the blocking member 8g on the stopping element 8i against which it bears—for this purpose the stopping elements 8i are slightly inclined—this draw compensating for the elastic return force exerted by the flexible guiding device 8b on the mobile frame 8a and being able to cause the wall of the second opening 8e to abut against the blocking member 8g as shown in FIG. 2. Then, approaching the following midnight, the drive member 8f contacts the other drive element 8h to displace the mobile frame 8a in translation in the other direction during a time interval overlapping midnight. At midnight, the displacement of the mobile frame 8a releases the assembly 5, 6, 8g, 11 which starts to turn, causing the date-indicating hand 6c to jump, until the blocking member 8g again abuts against the first stopping element 8i. The drive member 8f then leaves the drive element 8h with which it was in contact and continues its rotation without driving or touching the mobile frame 8a which is immobilised by the draw exerted by the blocking member 8g. Then, the cycle is repeated.

The displaying of the date is thus instantaneous and the energy which powers it is provided exclusively by the second source of energy 5, allowing the assembly formed by the first source of energy 2—first gear train 3—regulating member 4 to retain its duration of run and to not be disrupted by the displaying of the date. Moreover, friction is low because in normal operation the drive member 8f is in contact with the wall of the first opening 8d only when it co-operates with the drive elements 8h, i.e. in a cumulative manner over less than 60%, or even less than 50%, or even less than 40%, or even less than 30%, or even less than 20%, of one revolution of the drive member 8f. In the example illustrated in FIG. 2, the contact between the drive member 8f and the drive elements 8h occurs only over about 16% (about 8% per drive element 8h) of one revolution of the drive member 8f. Furthermore, even in the event of a shock or time-setting stopping the first gear train 3, the position of the indicating hand 6c is secured by the abutment of the blocking member 8g on one of the stopping elements 8.

The second source of energy 5 can have its own winding mechanism. Given that it is used only once per day, the second source of energy 5 also may not have a winding mechanism and can be wound only during regular maintenance of the watch.

The wall of the first opening 8d comprises two opposing circular arc parts 8j which have the same radius but different centres, the two junctions between these two parts 8j forming the drive elements 8h. The radius of the two circular arc parts 8j is slightly greater than the radius of the circle travelled by the end of the drive member 8f. Each circular arc part 8j, when the drive member 8f moves in front of it, has its centre which coincides with the centre of rotation of the drive member 8f. In this manner, during its rotation between the two drive elements 8h, the end of the drive member 8f follows the wall of the first opening 8d, thus protecting the blocking device 8 from shocks. Indeed, in the event of a shock received by the timepiece mechanism 1 which would tend to displace the mobile frame 8a in the direction (upwards in the configuration of FIGS. 1 and 2) which is unfavourable in terms of the blocking of the blocking member 8g, the wall of the first opening 8d immediately abuts against the end of the drive member 8f, which prevents release of the blocking member 8g. The position of the date-indicating hand 6c is thus secured.

The drive 8f and blocking 8g members can each have several fingers or teeth. By way of example, FIG. 3 shows one variant of the invention in which the blocking member 8g is in the form of a starwheel with three teeth. Moreover, as shown in this FIG. 3, the drive member 8f can be a relatively wide finger and its end 8k can be a circular arc centred on the centre of rotation of the drive member 8f and with a radius slightly smaller than the radius of the circular arc parts 8j of the wall of the first opening 8d. In the event of a shock received by the timepiece mechanism 1 which would tend to displace the mobile frame 8a in a direction which is unfavourable in terms of the blocking of the blocking member 8g, the wall of the first opening 8d immediately abuts against the drive member 8f, thereby preventing release of the blocking member 8g.

As also shown in FIG. 3, the blocking device 8 can comprise tension springs 8m (shown schematically) arranged to totally or partially compensate for the return force exerted by the flexible guiding device 8b. The mobile frame 8a is thus subjected to a zero return force or a weaker return force during its translational displacements.

It goes without saying that, as an alternative to the flexible guiding device 8b, the mobile frame 8a could be mounted in a slidable manner.

In the two latter cases mentioned above, where no elastic return force is exerted on the mobile frame 8a, the drawing force applied by the blocking member 8g upon its contact with the stopping element 8i displaces the mobile frame 8a until the wall of the second opening 8e abuts against the blocking member 8g, thereby immobilising the mobile frame 8a.

FIGS. 4 and 5 show another variant of the invention in which the mobile frame 8a is mounted to rotate about an axis 8n separate from the rotational axes 8p, 8q of the drive 8f and blocking 8g members. The drive 8f and blocking 8g members are here in the form of starwheels but they could also be simple fingers. The stopping elements 8i defined by the wall of the second opening 8e are circular arcs inclined such that the blocking member 8g exerts on the mobile frame 8a a draw which immobilises the mobile frame 8a by compensating for possible elastic return torque applied to the mobile frame 8a and/or by causing the wall of the second opening 8e to bear against the blocking member 8g.

Still referring to FIGS. 4 and 5, the wall 8r of the first opening 8d which receives the drive member 8f comprises two protrusions forming the drive elements 8h and is shaped to follow, over substantially 360°, the path of the tip of the finger or of a tooth of the drive member 8f in a coordinate system linked to the mobile frame 8a during rotation of the drive member 8f. This shape of the wall 8r of the first opening 8d allows the mobile frame 8a to abut immediately against the drive member 8f in the event of a shock in any direction and to thereby secure the blocking of the blocking member 8g. In the exemplified embodiments in FIGS. 1 to 3, the wall of the first opening 8d, with its circular arc parts 8j, is also shaped to follow, over substantially 360°, the path of the tip of the finger or of a tooth of the drive member 8f in a coordinate system linked to the mobile frame 8a during rotation of the drive member 8f.

FIG. 6 shows yet another variant of the invention in which the mobile frame 8a is replaced by two frames 8s, 8t which can move with respect to the framework of the timepiece mechanism 1 and can move with respect to each other. The first frame 8s comprises the first opening 8d which receives the drive member 8f and the second frame 8t comprises the second opening 8e which receives the blocking member 8g. These frames 8s, 8t are for example guided by respective flexible guiding devices and are kinematically connected to one another. In the illustrated example, the frames 8s, 8t are movable in translation and comprise respective racks 8u, 8v which mesh with a starwheel 8w. In variants, the frames 8s, 8t, or only one of them, could be movable in rotation.

By analogy with the exemplified embodiment of FIG. 6, it can be considered that the mobile frame 8a of FIGS. 1 to 5 comprises first and second mobile frames or parts 8a′, 8a″, these mobile frames or parts 8a′, 8a″ respectively having first and second openings 8d, 8e and being fixed relative to one another, thus kinematically connected to one another, and more particularly forming part of the same monolithic piece.

Numerous configurations other than those shown in the figures and described above are possible in the present invention. For example, instead of being coplanar, the openings 8d, 8e could be superimposed. The openings 8d, 8e could also be replaced by arms bearing tips fulfilling the function of the drive elements 8h and the stopping elements 8i. Furthermore, more than two drive elements 8h and/or more than two stopping elements 8i could be provided. For example, the wall of the first opening 8d could define additional drive elements to allow pre-winding of the mobile frame 8a or of the part 8a′ prior to its displacement causing the release of the blocking member 8g.

It goes without saying that for a person skilled in the art a value or information other than the date, such as the phase of the moon, the week, the day of the week or the month, could be displayed with the mechanism 1. The mechanism 1 can also be used not for displaying a value or information but for triggering a mechanism such as a striking mechanism.

FIG. 7 shows another example of application for the blocking device 8 according to the invention. In this other example, the blocking device 8 is used in a constant-force device if a timepiece mechanism 20. The mechanism 20 comprises a source of energy (not shown), typically a barrel, powering a jumping wheel 21 via a going gear train (not shown). The jumping wheel 21 is coaxial with a seconds wheel 22 but is free in rotation with respect to it. An intermediate spring 23 connects the jumping wheel 21 and the seconds wheel 22. The intermediate spring 23 is e.g. a hairspring one end of which is fixed relative to the jumping wheel 21 and the other end of which is fixed relative to the seconds wheel 22. The seconds wheel 22 meshes with the pinion of an escape wheel-and-pinion assembly 24 of a regulating member 25. The escape wheel-and-pinion assembly 24 receives its energy from the intermediate spring 23 which itself is periodically wound by the source of energy at each displacement of the jumping wheel 21. A substantially constant force, which does not depend on the winding state of the source of energy, is thus delivered to the escapement.

For the periodic winding of the intermediate spring 23, the jumping wheel 21 is coaxial with, and fixed relative to, the blocking member 8g of the blocking device 8 and the escape wheel-and-pinion assembly 24 is coaxial with, and fixed relative to, the drive member 8f of the blocking device 8. The rotation of the escape wheel-and-pinion assembly 24 causes the drive member 8f to turn, always in the same direction, which drive member 8f periodically releases the blocking member 8g and, with it, the jumping wheel 21, the going gear train and the source of energy by co-operating with the drive elements 8h. This release each time instantaneously wind the intermediate spring 23.

1. Blocking device (8) for a timepiece comprising:
first and second mobile parts (8a′, 8a″; 8s, 8t) kinematically connected to one another, the first mobile part (8a′; 8s) comprising a drive device (8h), the second mobile part (8a″; 8t) comprising a stopping device (8i),
a rotating drive member (8f) intended to turn in a single direction and arranged to co-operate with the drive device (8h) to displace the first mobile part (8a′; 8s), and thus the second mobile part (8a″; 8t), alternately in opposite directions, and
a rotating blocking member (8g) intended to be tensioned and arranged to co-operate with the stopping device (8i) to be blocked by the second mobile part (8a″; 8t) and released at determined times by said displacements of the second mobile part (8a″; 8t),
wherein
the stopping device (8i) is arranged so that the co-operation between the rotating blocking member (8g) and the stopping device (8i) immobilises the second mobile part (8a″; 8t) and thus the first mobile part (8a′; 8s) when the rotating drive member (8f) does not cooperate with the drive device (8h),
in normal operation, the rotating drive member (8f) is in contact with the first mobile part (8a′; 8s) only when it co-operates with the drive device (8h) over less than 60% of one revolution of the rotating drive member (8f).

2. Blocking device (8) as claimed in claim 1, wherein the first and second mobile parts (8a′, 8a″) are fixed relative to one another.

3. Blocking device (8) as claimed in claim 2, wherein the first and second mobile parts (8a′, 8a″) form or are part of a same monolithic piece (8a).

4. Blocking device (8) as claimed in claim 1, wherein the first and second mobile parts (8s, 8t) can move with respect to each other.

5. Blocking device (8) as claimed in claim 1, wherein that the first mobile part (8a′; 8s) has an opening (8d) with a closed contour receiving the rotating drive member (8f) and the wall of which defines the drive device (8h; 8d′).

6. Blocking device (8) as claimed in claim 5, wherein the wall of the opening (8d) of the first mobile part (8a′; 8s) comprises two opposing circular arc parts (8j) which have the same radius but different centres, the junctions between these two circular arc parts (8j) forming the drive device (8h).

7. Blocking device (8) as claimed in claim 1, wherein the rotating drive member (8f) is in the form of a finger or a starwheel.

8. Blocking device (8) as claimed in claim 1, wherein the second mobile part (8a″; 8t) has an opening (8e) with a closed contour receiving the rotating blocking member (8g) and the wall of which defines the stopping device (8i).

9. Blocking device (8) as claimed in claim 1, wherein the rotating blocking member (8g) is in the form of a finger or a starwheel.

10. Blocking device (8) as claimed in claim 1, wherein the drive device (8h) comprises first and second drive elements.

11. Blocking device (8) as claimed in claim 1, wherein the stopping device (8i) comprises first and second stopping elements.

12. Blocking device (8) as claimed in claim 1, wherein the first and second mobile parts (8a′, 8a″; 8s, 8t) are each movable in translation.

13. Blocking device (8) as claimed in claim 1, wherein the first and second mobile parts (8a′, 8a″) are each movable in rotation.

14. Blocking device (8) as claimed in claim 1, wherein the first and second mobile parts (8a′, 8a″; 8s, 8t) are guided by one or more flexible guiding devices (8b).

15. Blocking device (8) as claimed in claim 14, wherein the flexible guiding device(s) (8b) is/are arranged to allow displacement of the first and second mobile parts (8a′, 8a″; 8s, 8t) only in translation.

16. Timepiece mechanism (1) comprising a blocking device (8) as claimed in claim 1, the rotating blocking member (8g) being kinematically connected to an indicating member (6c) and allowing a jump displacement of the indicating member (6c).

17. Timepiece mechanism (20) comprising a blocking device (8) as claimed in claim 1, the rotating drive member (8f) being rotationally fixed relative to an escape wheel-and-pinion assembly (24), the rotating blocking member (8g) being rotationally fixed relative to a jumping wheel (21) powered by a source of energy and connected by a spring (23) to a seconds wheel (22) which meshes with the escape wheel-and-pinion assembly (24), the spring (23) thus powering the escape wheel-and-pinion assembly (24) via the seconds wheel (22) and being wound by the source of energy at each release of the rotating blocking member (8g).

18. The blocking device of claim 1, wherein in normal operation, the rotating drive member (8f) is in contact with the first mobile part (8a′; 8s) only when it co-operates with the drive device (8h) over less than 50% of one revolution of the rotating drive member (8f).

19. The blocking device of claim 1, wherein in normal operation, the rotating drive member (8f) is in contact with the first mobile part (8a′; 8s) only when it co-operates with the drive device (8h) less than 40% of one revolution of the rotating drive member (8f).

20. The blocking device of claim 1, wherein in normal operation, the rotating drive member (8f) is in contact with the first mobile part (8a′; 8s) only when it co-operates with the drive device (8h) less than 30% of one revolution of the rotating drive member (8f).
